(19) United States
(12) Patent Application Publication
(10) Pub. No.: US 2004/0134967 A1
(43) Pub. Date: Jul. 15, 2004

(54) Interface engineered high-Tc Josephson junctions

(75) Inventors: Brian H. Moeckly, Palo Alto, CA (US); Kookrin Char, Palo Alto, CA (US)

Correspondence Address: Anna M. Nelson, MERCHANT & GOULD P.C., P.O. Box 2903, Minneapolis, MN, 55402-0903, US

(73) Assignee: Conductis, Inc., Sunnyvale, CA (US)

(21) Appl. No.: 10/704,215

(22) Filed: Nov. 6, 2003

Related U.S. Application Data
(63) Continuation of application No. 09/082,486, filed on May 20, 1998, now abandoned.
(60) Provisional application No. 60/047,555, filed on May 22, 1997.

(51) Int. Cl. B23K 1/00

(52) U.S. Cl. 228/101

(57) ABSTRACT

A process is provided for fabricating YBa₂Cu₃O₇ thin-film edge junctions in which no deposited barrier is employed. These devices display excellent RSJ-type I-V characteristics with values of I_{c} and Rₙ tunable over a useful range for operation of digital circuits.

### CROSS-REFERENCE TO OTHER APPLICATIONS

This is a continuation-in-part of U.S. Provisional patent application Ser. No. 60/047,555, filed May 22, 1997.

### STATEMENT OF GOVERNMENT INTEREST

This invention was made with United States Government support under Contract No. N0014-96-C-2095 awarded by the Naval Research Laboratory. The United States Government has certain rights in the invention.

### FIELD OF THE INVENTION

This invention relates to high temperature superconductor (“HTS”) Josephson junctions. More particularly, it relates to HTS Josephson junctions having an engineered Junction interface without a separate barrier layer.

### BACKGROUND OF THE INVENTION

Since the 1986 discovery of the new class of oxide superconductors, also known as high temperature superconductors (HTS), cuprate superconductors, and perovskite superconductors, many attempts have been made to fabricate useful junctions, devices, circuits, and systems. This discovery promised to bring the many benefits of superconductors to electronic circuits at a practically attainable temperature. Achieving these benefits, however, has been less than straightforward due to the nature of the materials, which is quite different from the metals and semiconductors normally used in electronics applications.

The first obstacle, now largely overcome, was the polycrystalline nature of these new ceramic superconductors. Traditional low temperature superconductors, having a superconducting transition temperature T_{c}<23 K, are metals, metal alloys, or intermetallic compounds. Metals are usually polycrystalline, but metallic bonding is so delocalized that the grain boundaries in these materials are not electrically active. Furthermore, coherence lengths in these superconductors are on the order of 100 nm, which is much larger than the size of a single grain, i.e., a single crystallite making up part of the polycrystalline body. This means that the superconducting electron pairs are affected by the average environment produced by many individual grains and so are not extremely sensitive to inhomogeneities at grain boundaries or other regions whose size is much less than a coherence length.

The cuprate superconductors are ceramic materials with ionic and covalent bonds that are more directional and localized than metallic bonds. Across grain boundaries atoms are displaced with respect to their normal positions in the ideal crystal. Chemical bonds between these displaced atoms are stretched, bent, broken, and sometimes vacant, depending on the atoms considered and their relative displacements in distance and angle from their ideal positions. This sort of disruption of the electronic structure of the material, much more severe with directional bonding than with isotropic metallic bonding, can cause corresponding disruptions in the transport properties of the material. It is for this reason that bulk polycrystalline specimens of the cuprate superconductors typically have critical current densities, which are reduced by an order of magnitude or more when compared to well oriented epitaxial films of the same chemical composition.

Another exacerbating factor is the very small and anisotropic coherence length of the superconducting perovskites. The coherence length in these materials has been estimated at about 1.5 nm in the a-b plane and about ten times less (0.15 nm) in the c-direction. These distances are much smaller than the dimensions of a typical grain, and are of the order of the lattice constant in the c-direction in YBa₂Cu₃O_{7-δ} (0≦δ≦1). The result is that the electrical properties of these superconductors are strongly influenced by the microstructure as well as the local environment of defects, including impurity atoms, vacancies, voids, dislocations, stacking faults, and grain boundaries.

With such a small coherence length, virtually any deviation from perfection can interrupt the flow of supercurrent enough to form a junction. Early thin films were so full of grain boundary junctions, due to their poor in-plane epitaxy, that the inherent properties of the material were masked by the behavior of thousands of weak-link junctions occurring naturally in the polycrystalline layers. By the early 1990s, however, the crystal growth technology had progressed to a state in which high-quality, well oriented epitaxial layers of high temperature superconductors could be grown by a variety of techniques and on a variety of substrates, so that well characterized junctions could be made in several ways. Most of these junctions, however, were deficient in one or more characteristic desirable for use in digital electronics or superconductive quantum interference devices (“SQUIDs”).

The Josephson junction is one of the basic elements of superconductor electronic devices, and is well-developed in low temperature superconductors. For high-temperature superconductors, however, development of a technology for reproducible junctions has been difficult. The first reported, intentionally fabricated, junctions were of the weak-link type. They are characterized by a critical current density J_{c}, a critical current I_{c}, an effective device cross-sectional area A, junction resistance, Rₙ, and normalized junction resistance RₙA. Later, junctions with an interlayer of an insulating material (SIS junctions) or normal metal (SNS junctions) were developed. However, few of these approaches were commercially useful, and none met all of the requirements for a useful technology. To make good electronic devices and circuits from the oxide superconductors, a manufacturable junction technology must be developed.

A manufacturable technology is one that gives reproducible and predictable results when a defined series of processing steps is carried out. The devices perform as designed, and the processes are robust, that is, are sensitive to small changes in processing parameters. A particular requirement of the technology is that all necessary processing steps should be compatible, so that one step does not destroy the results of a step that must be performed earlier in the flow.

The junctions formed by this technology should meet design criteria as specified by the user. The junctions must perform reliably at a specified temperature. They must carry a current density of 100 to 100,000 A/cm², at the designer's discretion, and must do so for the foreseeable lifetime of the device. Fluctuations in the critical current of each junction, as well as variations from junction to junction in a circuit, must be minimized. Noise must be reduced to a level at which random signals due to noise are much smaller and less common than the true signals the circuit is designed to detect.

For useful superconducting quantum interference devices (SQUIDs) it is necessary to fabricate matched pairs of junctions in a predetermined geometrical relationship. Not only must each junction have predictable qualities, but they must be easy to position at will. In practical terms, this implies that all of the materials used in a circuit should be patterned using similar techniques.

Development of a HTS circuit technology has remained elusive because of the difficulty of fabricating reproducible, uniform Josephson elements that possess suitable electrical properties for applications such as single flux quantum (SFQ) logic and SQUIDs. The state of the art is the ramp-edge process employing a Co-doped YBCO barrier layer. This process is described in Char, et al., U.S. Pat. No. 5,696,392 “Improved Barrier Layers for Oxide Superconductor Devices and Circuits,” which is incorporated herein by reference. The devices disclosed by Char, et al. and further refined as disclosed in W. H. Mallison, S. J. Berkowitz, A. S. Hirahara, M. J. Neal, and K. Char, “A multilayer YBa2Cu3Ox Josephson junction process for digital circuit applications,” Appl. Phys. Lett., vol. 68, pp. 3808, 1996, have spreads in junction parameters approaching that which is needed to make multi-junction circuits. However, these junction appear to operate as true proximity-effect elements—their values of Rₙ are quite low due to the low resistivity of the barrier material in their SNS configuration. Therefore, most of their usefully high I_{c}Rₙ product derives from a relatively high I_{c}, outside the range that is useful for SFQ devices. SFQ technology holds promise in high speed switching. Moreover, difficulty with the deposition of reproducible Co—YBCO films has limited the exploitation of those junctions.

Other types of high-T_{c} SNS geometry junctions have clearly been plagued by an excess resistance that does not correlate with that of the barrier material. This resistance has been shown to exist at the YBCO/barrier interface, most likely arising from oxygen disorder due to mismatches in lattice and thermal expansion coefficients. Unfortunately, although the Rₙ of these devices is in a useful range, their uncontrollable excess resistance makes them unsuitable for a reproducible junction technology. Indeed, we speculate that the primary weak-link effect in many of these devices arises specifically because of the weakened superconductivity at the interface, not due to the intended proximity effect.

Successful manufacture of Co—YBCO junctions has required great care in order to insure elimination of an excess interface resistance. If we are to increase the Rₙ of these devices, two obvious options become apparent: (1) add an excess interface resistance, or (2) increase Rₙ of the barrier layer, while preserving a negligible interface resistance. Unfortunately, we don't know how to perform the first item uniformly, and the second task requires the deposition of a high-resistivity, lattice-matched, pinhole-free barrier on the scale of a few nm. Such materials expertise is presently beyond our capability, and thus, ideal junctions using Co—YBCO are not yet commercially practicable. Furthermore, it is not at all clear that I_{c}Rₙ remains high for high-resistivity barriers.

Josephson junctions have also been reported using surface-treated YBCO as the barrier. For example, R. B. Laibowitz, R. H. Koch, A. Gupta, G. Koren, W. J. Gallagher, V. Foglietti, B. Oh, and J. M. Viggiano, Appl. Phys. Lett. 56, 686 (1990) used ion milling to damage the interface followed by ex-situ, low-temperature plasma oxyfluoridation to repair the damage. K. Harada, H. Myoren, and Y. Osaka, “Fabrication of all-high-Tc Josephson junction using as-grown YBa2Cu3Ox thin films,” Jap. J. Appl. Phys., vol. 30, pp. L1387, 1991, report ion plasma treated YBCO surfaces exhibiting Josephson behavior. C. L. Jia, M. I. Faley, U. Poppe, and K. Urban, “Effect of chemical and ion-beam etching on the atomic structure of interfaces in YBa2Cu3O7/PrBa2cu3O7 Josephson junctions,” Appl. Phys. Lett., vol. 67, pp. 3635, 1995, report that ion milling produces a surface phase of PBCO consistent with a cubic structure. However, these surface methods fail to achieve a sufficiently reproducible modified-surface barrier high-T_{c} junction technology.

### OBJECTS OF THE INVENTION

It is therefore the primary object of this invention to provide a Josephson junction having reproducible properties with a high Rₙ and low interface resistance. It is a further object of the invention to provide a method for fabricating a Josephson junction having a high, reproducible, and controllable I_{c}Rₙ product.

### SUMMARY OF THE INVENTION

These and other objectives are met by providing an electronic device comprising a crystalline substrate; a first superconductive element formed on and epitaxial to the substrate, the superconductive element comprising a superconductive oxide having a surface comprising a barrier means; a second superconductive element formed on and epitaxial to the first superconductive element, whereby a Josephson junction is formed between the first superconductive element and the second superconductive element. In contrast to prior art Josephson junctions which relied on grain boundaries at which crystalline lattice changed direction or on metallic or insulating barrier layers, the edge-junction of the present invention is formed without deposition of any barrier at all.

The invention takes advantage of a property of the notoriously complex YBCO material; that its electrical properties are tunable over a wide range, from an insulator to a superconductor, by altering its oxygen content and order, changing its crystal structure, or by adding dopants. The present invention uses this property to create a thin layer of high-resistivity material on the junction edge by altering the structure or chemistry of YBCO only at the surface. If this is done prior to deposition of the YBCO counterelectrode, a high Rₙ, device is formed. In the present invention, the surface of a first layer of YBCO is modified by using a combination of vacuum annealing and plasma treatment. Unlike previous attempts in which a junction was formed ex situ via ion milling or etching, the current invention does not alter the crystallinity of the superconductive oxide, and thus, does not lead to weakened superconductivity in the second layer due to lattice mismatch at the interface.

### BRIEF DESCRIPTION OF THE DRAWINGS

FIG. 1 is a schematic representation of a side view of a junction of the invention;

FIG. 2 shows the processing steps used to form the interface-engineered junction

FIG. 3 illustrates an I-V curve for an interface-engineered junction over the temperature range 4.2 K to 60 K. Rₙ of this 4 μm×0.15 μm device is 3 Ω;

FIG. 4 illustrates examples of the dependence of I_{c} on temperature for several junctions of the invention;

FIG. 5 illustrates the dependence of I_{c} on applied magnetic field at 40 K for a junction with Rₙ of 2.9 Ω;

FIG. 6. shows the range of I_{c}Rₙ and Rₙ which is presently attainable at 4.2 K for our junction process. The data are plotted as a function of J_{c}, and the lines represent least-square fits to the data. The junction area is 4 μm×0.15 μm;

FIG. 7 shows values of I_{c} and Rₙ at 4.2 K for a 10-junction test chip. The 1σ values are 7.8% for I_{c} and 3.5% for Rₙ.

### DETAILED DESCRIPTION OF THE INVENTION

Formation of the Junctions of the Invention

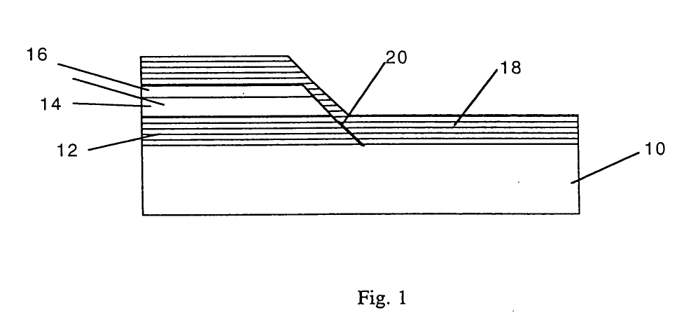

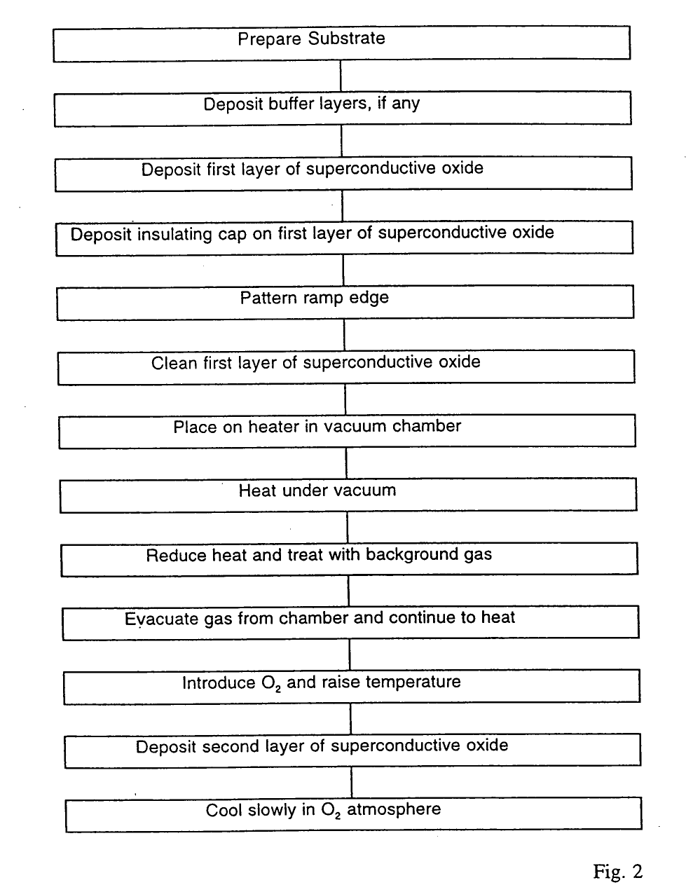

FIG. 1 is a schematic cross-sectional representation of a junction of the invention. The drawing is not to scale. FIG. 2 is a flow schematic of the preferred process for forming the superconducting device of the invention.

A suitable crystalline substrate 10 for the structure is selected; for the purposes of illustration, (001) LaAlO₃ has been chosen. Any substrate suitable for supporting epitaxial growth of an oxide superconductor, either alone or with an intermediate buffer layer may be used. Suitable substrates include MgO, LaAlO₃, sapphire, yttrium-stabilized zirconia, strontium titanite and the like. These substrates are well known in the literature. The preferred substrate is LaAlO₃ As used herein, the term crystalline substrate refers to a support material having major crystallographic axes and having a lattice structure suitable for the growth of a superconducting oxide.

A buffer layer may be deposited on the substrate prior to deposition of the superconductive oxide. Buffer layers are generally used to provide chemical isolation from the substrate or to provide an improved lattice match between the substrate and the superconductive oxide. Suitable buffer layers include CeO₂, SrTiO₃ and CaTiO₃. The buffer layer and the superconductive oxide may be deposited using any of several known methods for achieving epitaxial growth of the oxide, including laser ablation, and reactive coevaporation. In the example, a buffer layer of CeO₂ and a first superconducting layer 12 of YBa₂Cu₃O_{7-δ} (YBCO), about 150 nm in this case, were deposited on the substrate. However, the invention should not be viewed as limited to YBCO. Other oxide superconductors may also be used.

Normal deposition conditions for these materials, when deposited by laser ablation, are: substrate temperatures about 780° C.±20° C., oxygen pressure 100-600 mT, more preferably, 300-400 mT, laser energy about 2-5 J/cm² at the target. More detailed process conditions for epitaxial film growth are described in many publications.

Next an insulator, in this case a layer of PBCO 14 capped with a layer of epitaxial SrTiO₃ 16, is deposited to prevent contact between the first superconducting layer 12 and the second superconducting layer 18. Other insulators having good insulating properties, suitable lattice structures and chemical compatibility with the superconductor may be used.

The first superconducting layer 12 and the overlying insulators 14, 16 are then patterned as desired. For the devices whose test results are shown, patterning was accomplished with standard photolithography and inert ion etching.

Prior to insertion into the laser ablation vacuum chamber, the edge is prepared with an Ar ion mill clean at 500 V for one minute. Other voltages and times of Argon milling are within the scope of the invention. The sample is then heated in vacuum, preferably in the range of 10⁻⁵ to 10⁻⁷ Torr to between 400 and 500° C., preferably about 450° C., for a period up to one hour. One half hour is preferred. We have discovered that slightly above this temperature in vacuum, bulk orthorhombic YBCO films may be completely converted to a quasi-cubic phase.

Following this anneal, the pre-device is treated, in situ, to uniformly convert only the exposed YBCO surface 20 to a slightly different phase, structure, or chemical configuration. We accomplish this using a background gas of Ar and/or O₂ plasma generated by biasing the substrate heater with an rf source. The preferred background gas is Ar. A 1:1 mixture of Ar/O₂ is also acceptable. We have found that a plasma treatment with a forward power of 100-400 watts in a background total pressure of 10 to 100 mTorr, preferably 20-50 mTorr, is sufficient to form an interface material whose properties allow fabrication of Josephson devices. The typical reflected rf power is <10 W and the dc self-bias on the heater is typically 600-900 V. The precise conditions of the plasma are adjusted to achieve junctions with the desired parameters. We perform this plasma treatment for several minutes to an hour, preferably about 20 minutes, and follow it by a further optional vacuum anneal, preferably for about 1/2 hour at 400° C. Other gasses may be used as the background gas, including noble gasses such as Xe and halogens, such as F₂. If other gasses are used, the conditions may need to be adjusted to achieve the desired parameters. Persons skilled in the art would be able to make such adjustments.

Following the vacuum anneal, we introduce 300-400 mTorr of O₂- and increase the temperature to 785° C. Immediately thereafter, the YBCO counter-electrode is deposited under standard conditions. The bottom YBCO is re-oxygenated before and/or during the deposition, as its T_{c} remains quite high. Our test chips are patterned to form 5 junctions with widths of 4 μm each.

Junction Properties

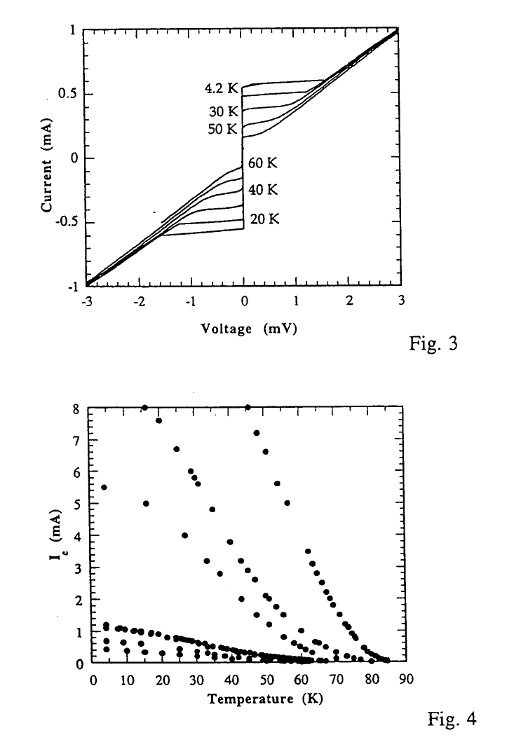

Our devices display RSJ-type I-V characteristics over the entire temperature range of operation; examples are shown in FIG. 3. This behavior may be contrasted with Co—YBCO edge junctions, whose temperature range of operation is limited due to their exponential I_{c}(T) dependence and the eventual onset of superconductivity in the barrier layer. FIG. 4 displays the I_{c}(T) dependence for a few of our new interface-engineered junctions. Note that the behavior is quasi-linear in accord with many types of high-T_{c} devices. Also, note that the temperature at which we begin to see a critical current decrease with decreasing I_{c}. This behavior is not due to thermal noise rounding alone, however, but also depends on the value of Rₙ of the device.

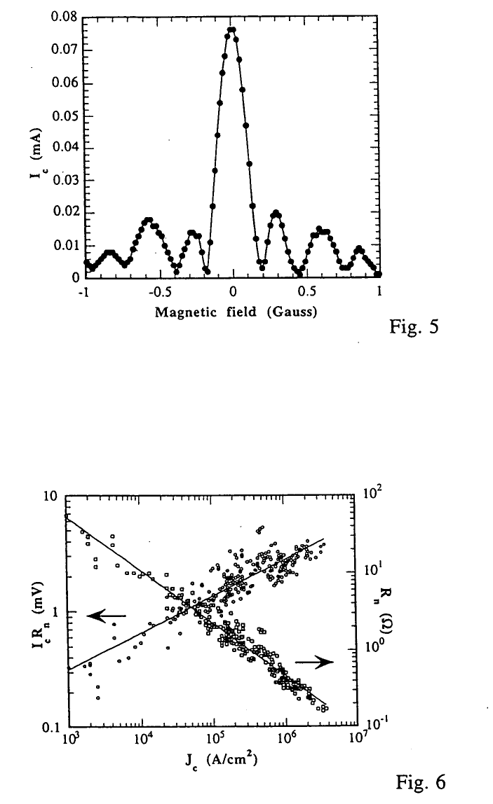

These junctions respond quite strongly to an applied magnetic field. The critical current modulates to zero in a few gauss at high temperatures, and I_{c}(H) displays a Fraunhofer-like pattern, as shown in FIG. 5. The periodicity is consistent with the physical width of the device if flux focusing is taken into account. Even at 4.2 K where excess current is notable, these junctions continue to modulate by 80 to 90% in the best cases.

In FIG. 6, we display the ranges of I_{c}Rₙ, and Rₙ that are attainable at 4.2 K. Note that I_{c}Rₙ products from 0.3 to 5 mV are possible at this time, with corresponding RₙA values of 3×10⁻⁷ to 1×10⁻⁹ Ωcm². A clear scaling relation exists between I_{c}Rₙ and J_{c} similar to that observed for grain boundary weak links, although the dependence is somewhat different for these interface-engineered junctions.

Even at higher temperatures, the parameters of these junctions make them quite attractive for applications. For example, at 40 K, I_{c}Rₙ values between 0.1 and 2 mV are easily obtained. Thus, junctions with I_{c}Rₙ products of 500 μV and corresponding I_{c} and Rₙ values of 500 μA and 1 Ω for a size of 4 μm×0.15 μm can be manufactured already.

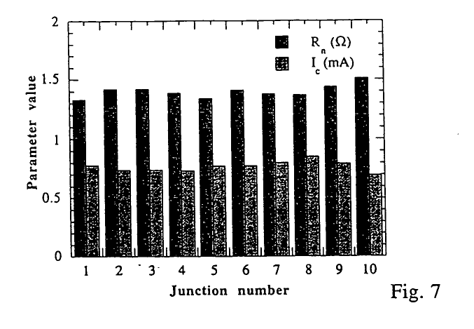

Of course, these junctions will never be useful for multi-junction circuits unless then can be made uniformly. We have begun to study spreads of these junctions made on 10- and 20-junction test chips. The best result so far is displayed in FIG. 7. This 10-junction chip displayed a 1σ spread in I_{c} of 7.8% and a spread in Rₙ of 3.5%. Our spreads over 20 junctions have been as low as 12% in I_{c} thus far.

Use of the Junctions of the Invention.

The junctions of the invention find use in a variety of applications. Josephson junctions are an essential feature of Superconducting Quantum Interference Devices (“SQUID(s)”), which are useful in magnetic sensing applications and as amplifiers. The junctions are also useful in digital logic devices, such as in high-speed switching and clock recovery circuits.

### CONCLUSION

The invention provides a method of fabricating all-YBCO Josephson junctions that intentionally avoid the deposition of a barrier layer. These devices appear to be uniform and reproducible. Every testable device of several hundred we have made has worked as a resistively shunted junction. Their electrical characteristics are easily adjustable within a range suitable for electronics circuit technology. For example, an I_{c} of several hundred μA and an Rₙ of 2 Ω at 40 K is ideally suited for RSFQ technology. The junctions are also well suited to making 1 Ω SQUIDs with an I_{c} of 1 mA at 40 K.

It would be apparent to one skilled in the art that variations of the process are within the scope of the invention. Other superconductive oxides may be used. The background gas may be varied, and could include other noble gasses or halogens, alone or in combination. Variations in time and temperature for various steps are within the scope of the invention.

While the foregoing disclosure contains many specificities, it should be understood that these are given by way of example only. The scope of the invention should not be limited by the specific examples given above, but only by the appended claims and their legal equivalents.

I claim:

1. An electronic device comprising:
(a) a crystalline substrate;
(b) an electrode formed on and epitaxial to the substrate, the electrode comprising a first superconductive oxide;
(c) an insulator formed on and epitaxial to the electrode;
(d) A barrier comprising a plasma-treated surface of the first superconductive oxide; and
(e) a counter-electrode formed on and epitaxial to the electrode and the barrier, the counter-electrode comprising a second superconductive oxide, whereby a Josephson junction is formed between the electrode and the counter-electrode.

2. The device of claim 1, wherein the barrier is a surface formed by treating the first superconductive oxide with a plasma comprising a gas selected from the group consisting of argon, xenon, oxygen, and halogen.

3. The device of claim 2, wherein the gas is argon gas.

4. The device of claim 2, wherein the gas is a 1:1 mixture of argon and oxygen.

5. The device of claim 1 wherein the first superconductive oxide has an a-b plane and a step-edge junction is formed in the a-b-plane of the first superconductive oxide.

6. The device of claim 1 wherein the first superconductive oxide has an a-b plane, the a-b plane is epitaxial to the substrate, and the second superconductive oxide is on and epitaxial to the first superconductive element, whereby a junction is formed perpendicular to the a-b plane of the first superconductive oxide.

7. The device of any of claims 1-6, wherein the first and the second superconductive oxide is YBCO.

8. A process for making a Josephson junction device comprising the steps of:
(a) preparing a substrate;
(b) depositing an electrode comprising a first layer of a superconductive oxide on the substrate;
(c) depositing an insulating layer on the first layer of superconductive oxide;
(d) patterning to form a pre-device having an exposed surface of the first superconductive oxide;
(e) placing the pre-device into a deposition chamber;
(f) forming a barrier on the exposed surface of the first layer of superconductive oxide by treating the exposed surface with a plasma; and
(g) depositing a second layer of a superconductive oxide on the pre-device, whereby a Josephson junction is formed between the first and the second superconductive oxides at the barrier.

9. The process of claim 8, wherein the treating is with a plasma of Ar gas at a pressure of between 10 and 100 mTorr.

10. The process of claim 8, wherein the treating is with a mixture of Ar and O₂ gas at a pressure of between 10 and 100 mTorr.

11. The process of any of claims 8-10, further comprising the step of vacuum annealing the pre-device prior to depositing the second superconductive oxide.
